(19) United States
(12) Patent Application Publication
(10) Pub. No.: US 2024/0178565 A1
(43) Pub. Date: May 30, 2024

(54) ANTENNA SYSTEM

(71) Applicant: Morphix, Inc., Vancouver, WA (US)

(72) Inventor: Jonathan Lovegrove, Yacolt, WA (US)

(21) Appl. No.: 18/515,023

(22) Filed: Nov. 20, 2023

Related U.S. Application Data
(60) Provisional application No. 63/385,096, filed on Nov. 28, 2022.

(51) Int. Cl. H01Q 5/55; H01Q 1/28

(52) U.S. Cl. CPC H01Q 5/55; H01Q 1/28

(57) ABSTRACT

An antenna system comprises a first plate and a second plate. The second plate is positioned below the first plate and separated by a gap from the first plate. The second plate is operatively configured to substantially block radio frequency (RF) transmissions.

### BACKGROUND

Vehicles such as remotely operated aircraft or autonomous aircraft can communicate via multidirectional radiofrequency (RF) communication signals. However, it can be challenging for such vehicles to operate in the presence of interference, jamming, or spoofing signals.

### SUMMARY

According to one aspect of the present disclosure, an antenna system is provided to address the issues discussed above. The antenna system comprises a first plate and a second plate positioned below the first plate and separated by a gap from the first plate. The second plate is operatively configured to substantially block radio frequency (RF) transmissions.

Another aspect of the present disclosure provides, at a computing device on board an aircraft, a method for controlling an antenna system comprising a first plate and a second plate parallel with the first plate and positioned below the second plate. The method comprises detecting a second aircraft and aligning an angular transmission range of the antenna system with an angular reception range of the second aircraft. The method further comprises outputting, via the antenna system, a communication to the second aircraft.

Yet another aspect of the present disclosure provides, at a computing device on board an aircraft, a method for controlling an antenna system comprising a first plate and a second plate parallel with the first plate and positioned below the second plate. The method comprises detecting a second aircraft and aligning an angular reception range of the antenna system with an angular transmission range of the second aircraft. The method further comprises receiving, via the antenna system, a communication from the second aircraft.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic diagram of a first aircraft communicating with a second aircraft via an example antenna system according to one example embodiment.

FIG. 2 shows the first aircraft of FIG. 1 and the example antenna system.

FIG. 3 shows a schematic diagram of another example aircraft according to another example embodiment.

FIG. 4 shows a schematic side-profile view of the example antenna system of FIG. 1.

FIG. 5 shows a schematic diagram of a collimator located at the example antenna system of FIG. 1.

FIG. 6 shows a flowchart of an example method for controlling an antenna system according to one example embodiment.

FIG. 7 shows a schematic diagram of an example computing system, according to one example embodiment.

### DETAILED DESCRIPTION

As introduced above, some vehicles can communicate via multidirectional radiofrequency (RF) communication signals. For example, remotely operated aircraft may be controlled by RF communication signals transmitted from a remote operator, or autonomous aircraft may communicate with one another via RF communication signals. However, RF interference from other RF sources within reception range of a vehicle may render the RF communication signals indistinguishable from the RF interference. In other instances, jamming signals may prevent RF communications from reaching the vehicle, or spoofing signals may hijack RF communications with the vehicle. As a result, it can be challenging to operate such vehicles in the presence of RF interference, jamming signals, or spoofing signals.

Accordingly, an antenna system is provided to address the issues discussed above. Briefly, the antenna system comprises a first plate and a second plate positioned below the first plate and separated by a gap from the first plate. The second plate is operatively configured to substantially block RF transmissions. In this manner, the antenna system enables directional RF transmission and reception within an angular transmission range and an angular reception range of the antenna system, respectively. Additionally, the second plate is operatively configured to substantially block RF transmissions. In this manner, the antenna system may prevent RF interference, jamming, or spoofing signals from interrupting RF communications.

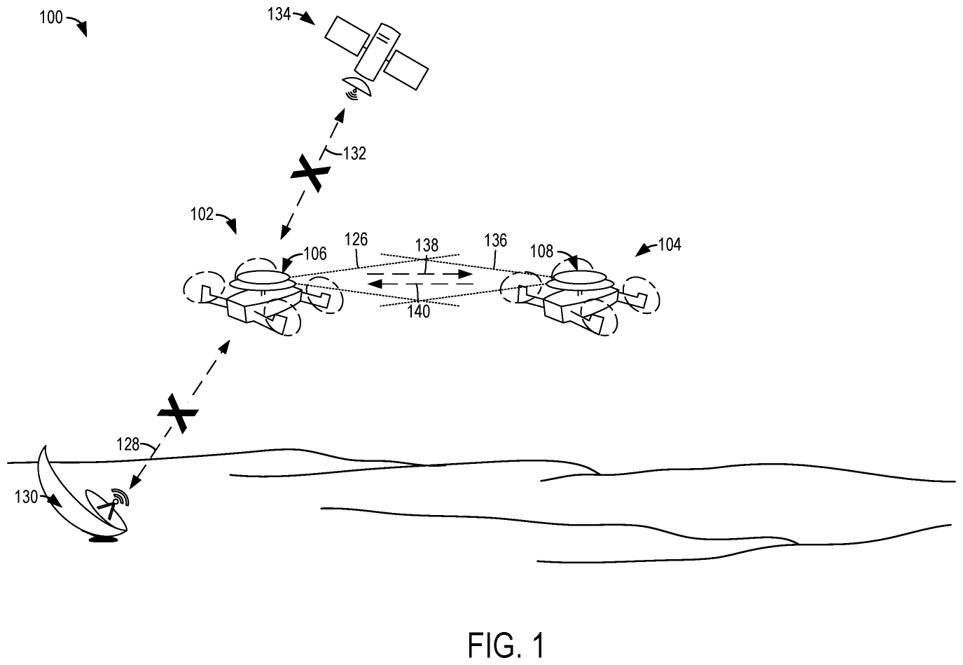

FIG. 1 shows an example of an environment 100 comprising a first aircraft 102 and a second aircraft 104 in the form of quadcopter drones. It will also be appreciated that the first aircraft 102 and/or the second aircraft 104 may comprise any other suitable type of aircraft. Other examples of suitable aircraft include, but are not limited to, a helicopter and a fixed-wing aircraft.

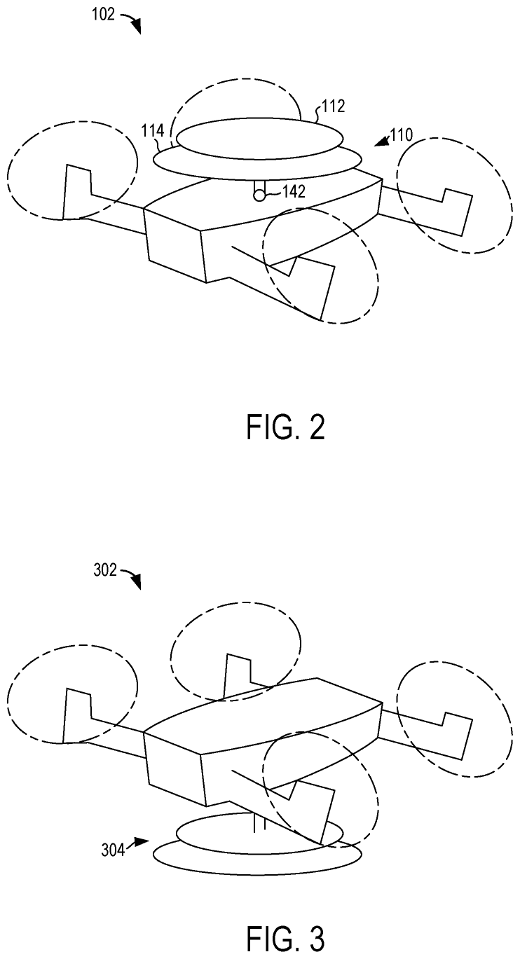

The first aircraft 102 includes a first antenna system 106 and the second aircraft include a second antenna system 108. Each antenna system comprises a waveguide. For example, FIG. 2 shows a waveguide 110 connected to the first aircraft 102 of FIG. 1. The waveguide 110 comprises a first plate 112 and a second plate 114. The first plate 112 and the second plate 114 serve as boundaries of the waveguide 110.

In some examples, the first plate 112 and the second plate 114 each comprise a planar disk. In some more specific examples, the first plate 112 and the second plate 114 comprise coaxial planar disks. For example, the first plate 112 is centered on the second plate 114. In other examples, the first plate 112 and/or the second plate 114 may have any other suitable shape(s). Other examples of suitable shapes include, but are not limited to, square and triangular plates.

As illustrated by example in FIGS. 1-2, the antenna system 106 is positioned on top of the first aircraft 102. In this manner, one or more other structures, such as cargo, a camera, or a weapon system, may be positioned below the first aircraft 102. FIG. 3 shows another example of an aircraft 302 comprising an antenna system 304 located below the aircraft. In yet other examples, the antenna system may be in line with a fuselage of the aircraft.

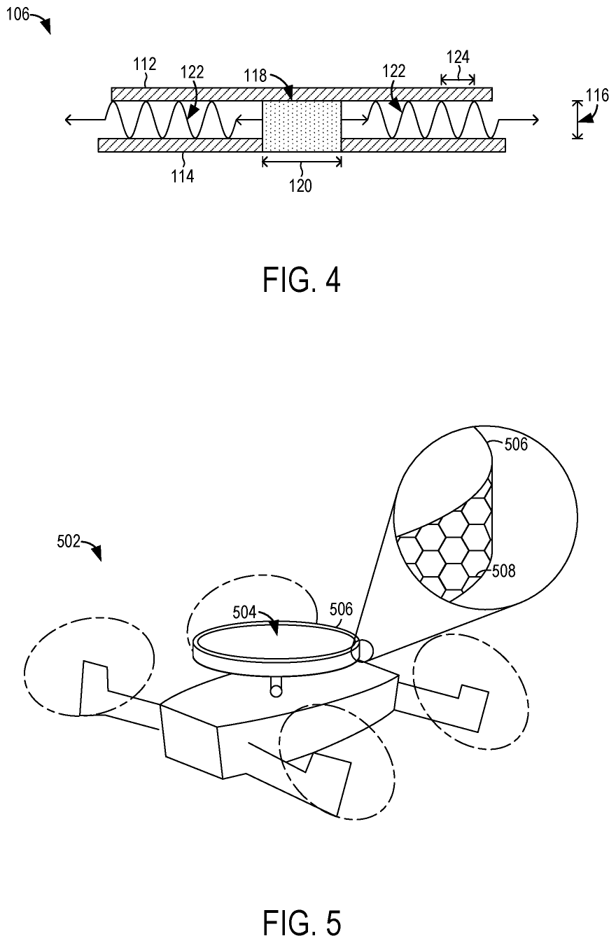

As described above, the first plate 112 and the second plate 114 are boundaries of the waveguide 110. In some examples, the second plate 114 is positioned below the first plate 112. The second plate 114 is separated by a gap 116 from the first plate 112. The antenna system 106 further comprises an RF transceiver 118. In some examples, the RF transceiver 118 is at least partially located within the gap 116. In the example depicted in FIG. 4, the second plate 114 comprises an aperture 120. The aperture 120 accommodates the RF transceiver 118. In this manner, the RF transceiver 118 is configured to transmit and/or receive RF waves 122 within the gap 116. The gap 116 is proportional to a wavelength 124 of the RF waves 122. In this manner, the first plate 112 and the second plate 114 are operatively configured to propagate the RF waves 122 within the gap 116 in a direction parallel to the first plate 112 and the second plate 114.

The first plate 112 and the second plate 114 comprise a material having a permittivity suitable to propagate the RF waves 122 within the gap 116. Accordingly, the material composition of the first plate 112 and/or the second plate 114 may be selected based upon a frequency/wavelength of the RF waves. Some examples of suitable materials for the first plate 112 and/or the second plate 114 include, but are not limited to, polymers, alloys, and coated materials. The material of the first plate 112 and the second plate 114 also has a suitable weight to operate in flight on the aircraft 102. It will be appreciated that, in some examples, the first plate 112 and the second plate 114 comprise a same material. In other examples, the first plate 112 and the second plate 114 comprise different materials.

As described in more detail below, the first plate 112 and the second plate 114 enable RF transmissions to be sent and received within an angular transmission/reception range 126. The first plate 112 and the second plate 114 are operatively configured to substantially block RF transmissions outside of the angular transmission/reception range 126. For example, and with reference again to FIG. 1, the second plate 114 is configured to prevent the first aircraft 102 from receiving an RF transmission 128 from a ground-based electronic warfare transmitter 130. Similarly, the first plate 112 is configured to substantially block an RF transmission 132 from a satellite 134. This protects the first aircraft 102 from RF interference or attacks from above and below the first aircraft.

With reference again to FIG. 2, in some examples, the second plate 114 is larger than the first plate 112. For example, the second plate 114 comprises a circular disk that has a larger radius than the first plate 112. Accordingly, the second plate 114 projects beyond a circumference of the first plate 112. This helps to prevent an RF transmission from below the second plate, such as the RF transmission 128 of FIG. 1, from entering the gap 116.

In some examples, the aircraft additionally or alternatively comprises a collimator. FIG. 5 shows another example of an aircraft 502 comprising an antenna system 504. The aircraft 502 further comprises collimator 506. The collimator 506 comprises a honeycomb structure 508 that surrounds a circumference of the antenna system 504. The honeycomb structure 508 is configured to reflect or absorb RF energy that is not aligned to the honeycomb structure 508. In this manner, the collimator further protects the aircraft from RF interference or attacks.

In some examples, the antenna system is further configured to direct or focus the RF energy at a predetermined portion of the environment. For example, one or more RF interference transmitters may be used to broadcast RF interference into at least a portion of the antenna system. In this manner, the RF interference may prevent radial transmission of the RF energy in one or more predetermined directions.

Referring again to FIG. 4, the gap 116 enables the antenna system 106 to transmit or receive RF signals within a narrow angular reception range relative to an omnidirectional aircraft radio. As illustrated by example in FIG. 1, the first plate 112 and the second plate 114 of the first antenna system 106 are aligned within a second angular transmission/reception range 136 of the second antenna system 108. The first aircraft 102 maintains an altitude within the angular transmission/reception range 136 of the second antenna system 108. The first aircraft 102 also maintains an attitude that aligns the first antenna system 106 to the angular transmission/reception range 136. Likewise, the second aircraft 104 maintains an altitude within the angular transmission/reception range 126 and an attitude that aligns the second antenna system 108 with the angular transmission/reception range 126. This allows the first aircraft 102 to send RF transmissions 138 to the second aircraft 104 and to receive RF transmissions 140 from the second aircraft. The RF transmissions 138 and 140 are more secure than omnidirectional RF transmissions, as the RF transmissions 138 and 140 cannot be intercepted or spoofed by systems outside of the angular transmission/reception ranges of the first aircraft and the second aircraft.

In some examples, the first aircraft 102 and/or the second aircraft 104 is configured to adjust one or more flight characteristics to obtain a peak signal-to-noise ratio of the RF transmissions 138 and 140. Some examples of suitable flight characteristics include altitude, speed, and attitude. For example, the first aircraft 102 may change its altitude to re-align with the second aircraft 104 if there is a disruption in the RF signal. In this manner, the first aircraft 102 may maintain communications with the second aircraft 104.

With reference again to FIG. 2, in some examples, the first aircraft 102 further comprises a gimbal 142 coupling the antenna system 106 to the first aircraft 102. In some examples, the gimbal 142 comprises an active gimbal operatively configured to maintain an orientation of the first plate 112 and the second plate 114. For example, the active gimbal may be tied to a flight controller of the first aircraft 102. In this manner, the active gimbal may proactively, adjust an orientation of the antenna system 106 to account for changes in one or more flight characteristics. For example, the flight controller may transmit a signal to the active gimbal indicating that the first aircraft is moving from a hovering orientation into a forward-pitched orientation, in which the antenna system 106 is pitched towards the second aircraft 104. Accordingly, the active gimbal may pitch the antenna system 106 up by an equal angle to compensate for the pitch of the aircraft. In this manner, the gimbal may maintain alignment of the antenna system 106 with the second antenna system 108 of the second aircraft 104.

In some examples, the antenna system is operatively configured to transmit and receive in a frequency range of 60-80 GHz. Radio signals within this frequency range attenuate more rapidly with distance than at other frequencies. This can prevent unauthorized receipt of the radio signals. It will also be appreciated that frequency channels may be electronically filtered to prevent interference. Furthermore, radio signals within this frequency range can be focused within the angular transmission/reception range 126. In addition, antennas that operate within this frequency range are sufficiently small to operate on board the first aircraft 102 in flight. In other examples, the antenna system is operatively configured to transmit and receive at any other suitable frequency. Other examples of suitable frequencies include, but are not limited to, frequencies less than 60 GHz and frequencies greater than 80 GHz.

It will also be appreciated that, in some examples, the first aircraft 102 and the second aircraft 104 dynamically select a communication frequency. For example, the first aircraft and the second aircraft 104 may switch from a first frequency to a second frequency if signal quality degrades on the first frequency or if the first frequency reaches capacity. In some such examples, signals may be split between the first frequency and the second frequency. This may smooth the transition from the first frequency to the second frequency.

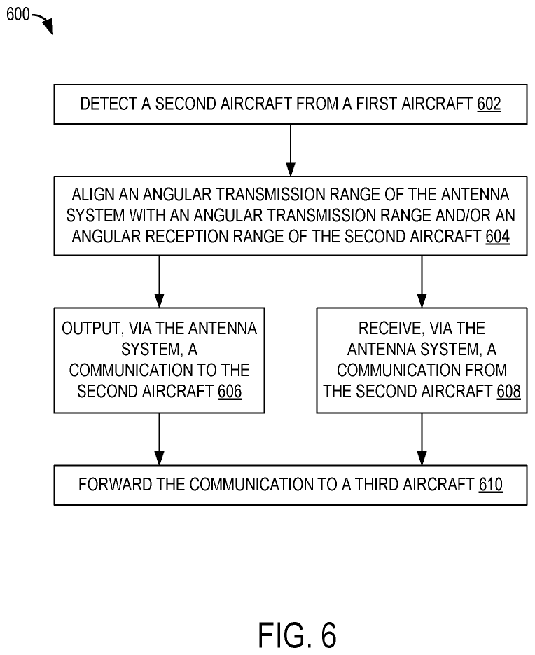

With reference now to FIG. 6, a flowchart is illustrated depicting an example method 600 for controlling an antenna system. The following description of method 600 is provided with reference to the components described above and shown in FIGS. 1-5 and 7. It will be appreciated that method 600 also may be performed in other contexts using other suitable hardware and software components. It will also be appreciated that the following description of method 600 is provided by way of example and is not meant to be limiting. It will be understood that various steps of method 600 can be omitted or performed in a different order than described, and that the method 600 can include additional and/or alternative steps relative to those illustrated in FIG. 6 without departing from the scope of this disclosure.

The method 600 comprises, at 602, detecting a second aircraft from a first aircraft. For example, the first aircraft 102 of FIG. 1 may detect the second aircraft 104 prior to engaging in RF communications with the second aircraft. For example, first aircraft may detect the second aircraft via a camera. Visual recognition of the second aircraft is not susceptible to RF jamming or interference. In addition, visual recognition allows the first aircraft and the second aircraft to remain silent prior to initiating RF communication with each other. This prevents the aircraft from unintentionally betraying their locations or other information.

At 604, the method 600 comprises aligning an angular transmission range of the antenna system with an angular transmission range and/or an angular reception range of the second aircraft. For example, the first aircraft 102 and the second aircraft 104 are at the same altitude as one another. The first aircraft 102 is aligned with the angular transmission/reception range 136 of the second aircraft 104. Likewise, the second aircraft 104 is aligned with the angular transmission/reception range 126 of the first aircraft 102. This enables the first aircraft and the second aircraft to communicate via the first antenna system and the second antenna system.

In some examples, at 606, the method 600 comprises outputting, via the antenna system, a communication to the second aircraft. For example, the first aircraft 102 of FIG. 1 is configured to output RF transmission 138 to the second aircraft 104. The second aircraft 104 is also configured to output RF transmission 140 to the first aircraft 102 of FIG. 1. The antenna system facilitates transmission of RF communications.

At 608, in some examples, the method 600 comprises receiving, via the antenna system, a communication from the second aircraft. For example, the first aircraft 102 of FIG. 1 is configured to receive the RF transmission 140 from the second aircraft 104. The second aircraft 104 is also configured to receive the RF transmission 138 from the first aircraft 102.

In some examples, the method 600 comprises, at 610, forwarding the communication to a third aircraft. For example, the second aircraft 104 of FIG. 1 may store a message relayed via the RF transmission 138. The second aircraft 104 may then transmit the message in another RF communication to another aircraft upon detecting the aircraft. The message may be iteratively relayed, for example by repeating one or more of steps 602-610, until reaching each aircraft of a plurality of aircraft (e.g., a drone swarm) or until reaching a predetermined aircraft within the plurality of aircraft. This enables communication within the plurality of aircraft.

In this manner, the methods and devices disclosed herein enable RF transmission and reception within an angular transmission range and an angular reception range. As described above, in some examples, an antenna system comprises a first plate and a second plate positioned below the first plate and separated by a gap from the first plate. The first plate and the second plate propagate RF waves in a direction parallel to the first plate and the second plate. This gives rise to the angular transmission/reception range of the antenna system. In addition, the second plate is operatively configured to substantially block RF transmissions, such as RF transmissions originating from below the first plate and outside of the angular transmission/reception range. In this manner, the antenna system may block RF interference or attacks.

In some embodiments, the methods and processes described herein may be tied to a computing system of one or more computing devices. In particular, such methods and processes may be implemented as a computer-application program or service, an application-programming interface (API), a library, and/or other computer-program product.

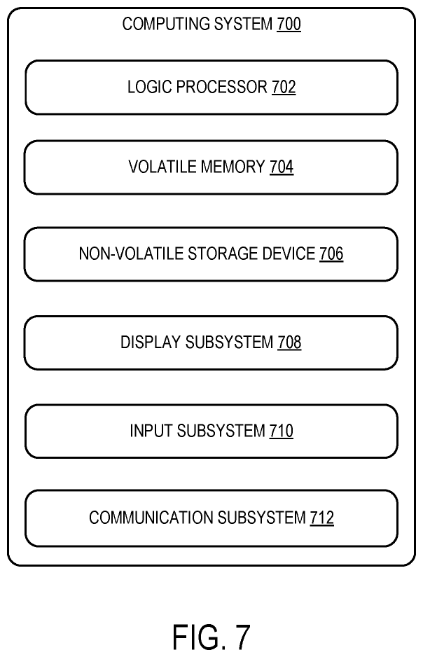

FIG. 7 schematically shows a non-limiting embodiment of a computing system 700 that can enact one or more of the methods and processes described above. Computing system 700 is shown in simplified form. Computing system 700 may take the form of one or more personal computers, server computers, and computers integrated with aircraft, as examples.

Computing system 700 includes a logic processor 702 volatile memory 704, and a non-volatile storage device 706. Computing system 700 may optionally include a display subsystem 708, input subsystem 710, communication subsystem 712, and/or other components not shown in FIG. 7.

Logic processor 702 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 706 includes one or more physical devices configured to hold instructions executable by the logic processors to implement the methods and processes described herein. When such methods and processes are implemented, the state of non-volatile storage device 706 may be transformed—e.g., to hold different data.

Non-volatile storage device 706 may include physical devices that are removable and/or built-in. Non-volatile storage device 706 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Volatile memory 704 may include physical devices that include random access memory. Volatile memory 704 is typically utilized by logic processor 702 to temporarily store information during processing of software instructions. It will be appreciated that volatile memory 704 typically does not continue to store instructions when power is cut to the volatile memory 704.

Aspects of logic processor 702, volatile memory 704, and non-volatile storage device 706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 700 typically implemented in software by a processor to perform a particular function using portions of volatile memory, which function involves transformative processing that specially configures the processor to perform the function. Thus, a program may be instantiated via logic processor 702 executing instructions held by non-volatile storage device 706, using portions of volatile memory 704. It will be understood that different programs may be instantiated from the same application, service, code block, object, library, routine, API, function, etc. Likewise, the same program may be instantiated by different applications, services, code blocks, objects, routines, APIs, functions, etc. The term “program” may encompass individual or groups of executable files, data files, libraries, drivers, scripts, database records, etc.

When included, display subsystem 708 may be used to present a visual representation of data held by non-volatile storage device 706. The visual representation may take the form of a graphical user interface (GUI). As the herein described methods and processes change the data held by the non-volatile storage device, and thus transform the state of the non-volatile storage device, the state of display subsystem 708 may likewise be transformed to visually represent changes in the underlying data. Display subsystem 708 may include one or more display devices utilizing virtually any type of technology. Such display devices may be combined with logic processor 702, volatile memory 704, and/or non-volatile storage device 706 in a shared enclosure, or such display devices may be peripheral display devices.

When included, input subsystem 710 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition: and an infrared, color, stereoscopic, and/or depth camera for machine vision and/or gesture recognition.

When included, communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 700 to send and/or receive messages to and/or from other devices via a network such as the Internet.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

“And/or” as used herein is defined as the inclusive or ∨, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. An antenna system, comprising:
a first plate;
a second plate positioned below the first plate and separated by a gap from the first plate, the second plate operatively configured to substantially block radio frequency (RF) transmissions.

2. The antenna system of claim 1, wherein the first plate and the second plate are operatively configured to propagate RF waves in a direction parallel to the first plate and the second plate.

3. The antenna system of claim 1, wherein the first plate comprises a first planar disk and the second plate comprises a second planar disk.

4. The antenna system of claim 3, wherein the first planar disk and the second planar disk are coaxial.

5. The antenna system of claim 1, wherein the second plate is larger than the first plate.

6. The antenna system of claim 1, wherein the second plate comprises an aperture.

7. The antenna system of claim 1, wherein the first plate and the second plate form a waveguide.

8. The antenna system of claim 1, further comprising a collimator.

9. The antenna system of claim 1, wherein the antenna system is operatively configured to transmit and receive in a frequency range of 60-80 GHz.

10. The antenna system of claim 1, further comprising a gimbal coupling the antenna system to an aircraft.

11. The antenna system of claim 10, wherein the gimbal comprises an active gimbal operatively configured to maintain an orientation of the first plate and the second plate.

12. The antenna system of claim 1, wherein the first plate and the second plate are aligned within an angular reception range of another antenna system.

13. An aircraft, comprising:
an antenna system comprising,
a waveguide comprising a first plate and a second plate positioned below the first plate and separated by a gap from the first plate, the second plate operatively configured to substantially block radio frequency (RF) transmissions.

14. The aircraft of claim 13, wherein the antenna system is positioned on top of the aircraft.

15. The aircraft of claim 13, further comprising a collimator.

16. The aircraft of claim 13, further comprising a gimbal coupling the antenna system to the aircraft.

17. The aircraft of claim 13, wherein the first plate comprises a first planar disk and the second plate comprises a second planar disk.

18. The aircraft of claim 13, wherein the first plate and the second plate are aligned within an angular reception range of another antenna system located at another aircraft.

19. At a computing device on board an aircraft, a method for controlling an antenna system comprising a first plate and a second plate parallel with the first plate and positioned below the second plate, the method comprising:
detecting a second aircraft;
aligning an angular transmission range of the antenna system with an angular reception range of the second aircraft; and
outputting, via the antenna system, a communication to the second aircraft.

20. At a computing device on board an aircraft, a method for controlling an antenna system comprising a first plate and a second plate parallel with the first plate and positioned below the second plate, the method comprising:
detecting a second aircraft;
aligning an angular reception range of the antenna system with an angular transmission range of the second aircraft; and
receiving, via the antenna system, a communication from the second aircraft.
